(19) United States
(12) Patent Application Publication
(10) Pub. No.: US 2004/0167026 A1
(43) Pub. Date: Aug. 26, 2004

(54) Microcapsule-containing composition, thermal recording material using the same and process of preparing microcapsule-containing composition

(75) Inventor: Koreshige Ito, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/784,775

(22) Filed: Feb. 24, 2004

(30) Foreign Application Priority Data
Feb. 25, 2003 (JP) 2003-47059

(51) Int. Cl. B41M 5/20

(52) U.S. Cl. 503/201

(57) ABSTRACT

Provided are a microcapsule-containing composition comprising microcapsules, each having a microcapsule wall comprising, as a constituent, at least one selected from polyurethane and polyurea produced by polymerizing a compound having active hydrogen and an isocyanate compound, and a compound of a transition element from Group IV in the long-form Periodic Table; and a thermal recording material wherein this composition is used to suppress changes in thermal recording sensitivity with the passage of time and exhibit excellent color reproduction.

### CROSS-REFERENCE TO RELATED APPLICATION

This application claims priority under 35 USC 119 from Japanese Patent Application No. 2003-47059, the disclosure of which is incorporated by reference herein.

### BACKGROUND OF THE INVENTION

1. Field of the Invention

The present invention relates to a microcapsule-containing composition which can be used in recording material, such as thermal recording material, a thermal recording material using the same and a process of preparing a microcapsule-containing composition.

2. Description of the Related Art

A thermal recording material which has been used as a recording medium for facsimiles, printers and others mainly used a material wherein a solid dispersion of an electron donating dye precursor is applied onto a support and dried. Recording material using an electron donating dye precursor has advantages that the starting material thereof can be easily obtained and high density of formed color and color forming rate are exhibited. However, this recording material has problems related to the storability and reliability of recorded images thereon. For example, the color of the images is easily changed in accordance with storage conditions after the images are recorded, or by heat or the adhesion of solvent or the like thereto. Thus, a great number of improvements have been investigated.

One of the suggested methods for improving the storability of recorded images is a method of encapsulating an electron donating dye precursor into microcapsules to separate the electron donating dye precursor and a color forming agent from each other in a thermal recording layer, thereby making the storability of images higher. This method makes it possible to give high color-formability and image stability.

A thermal recording material which is different from the aforementioned thermal recording material is the so-called diazo type thermal recording material, wherein a diazonium salt compound is used. Diazonium salt compounds are compounds which react with a phenol derivative or a compound having an active methylene group (coupler) so as to produce dyes. In addition, diazonium salt compounds have photosensitivity and the activity thereof is lost by irradiation with light. In recent years, by use of these propertis, diazonium salt compounds have been applied to thermal recording material. In the Journal of the Institute of Image Electronics Engineers of Japan Vol. 11, No. 4, 290-296 (1982) written by Kohji Satoh et al., there is suggested a light fixation type thermal recording material wherein a diazonium salt compound and a coupler are caused to react with each other by heat so as to form an image and subsequently the image can be fixed by irradiation with light.

However, thermal recording material using a diazonium salt compound has high chemical activity; therefore, the diazonium salt compound and a coupler react with each other gradually even at low temperature. Consequently, the thermal recording material has a limited shelf life. As a means for solving this drawback, in Journal of the Society of Electrophotography of Japan, Vol. 1.26, No. 2, 115-125 (1987) written by Tomomasa Usami et al., a method of encapsulating a diazonium salt compound into microcapsules to separate this compound from a coupler, water and a basic compound is suggested.

As one field to which thermal recording material is applied, attention has been devoted to multicolor thermal recording material. It has been said that it is more difficult to reproduce a multicolor image according to thermal recording than according to electrophotographic and ink-jet recording methods. This problem has been alleviated by laminating, on a support, two or more thermal recording layers made mainly of an electron donating dye precursor and a color forming agent, or two or more thermal recording layers each comprising a diazonium salt compound and a coupler which reacts with the diazonium salt compound by heat so as to form a color. However, in order to gain excellent color reproduction in such multicolor thermal recording material, it is essential to control the thermal color-formability of microcapsules therein at a high level.

In order to encapsulating an electron donating dye precursor and a diazonium salt compound into microcapsules, in general there have been frequently used methods of dissolving these compounds into an organic solvent (an oil phase), adding this oil phase to a solution of an aqueous solultion of a water-soluble polymer (a water phase), and then emulsifying the resultant mixture. By adding a monomer or prepolymer which will be wall material of the microcapsules to any one of the organic solvent phase (the oil phase) and the water phase in this method, it is possible to form polymer walls in the interface between the organic solvent phase (the oil phase) and the water phase, thereby forming microcapsules. This is described in “Microcapsules” written by Tomoji Kondoh and published by the Nikkan Kogyo Shimbun, Ltd. in 1970 and “Microcapsules” written by Tamotsu Kondoh et al. and published by Sankyo Shuppan Co., Ltd. in 1977. As material for the microcapsule walls formed by this method, various materials can be used, examples of which include gelatin, alginic acid salts, celluloses, polyurea, polyurethane, melamine resin, and nylon. Among these materials, polyurea and polyurethane are preferable for design of thermal recording material since they have a glass transition temperature from room temperature to about 200° C. and capsule walls made of polyurea or polyurethane exhibit thermal response.

As the process for producing the aforementioned microcapsules having polyurethane or polyurea walls, for example, the following method has been known from earlier times: a method of dissolving a diazonium salt and an electron donating dye precursor into an organic solvent; adding a polyvalent isocyanate to the solution; emulsifying this organic phase solution in a solution of an aqueous solultion of a water-soluble polymer; adding a catalyst for promoting polymerization reaction to the water phase, or raising the temperature of the emulsion to polymerize the polyvalent isocyanate compound with a compound having active hydrogen, such as water, thereby forming the capsule walls.

In multicolor thermal recording material, thermal recording layers in cyan, magenta and yellow are deposited. In these thermal recording layers, images are printed by receiving different heating temperatures given. For this reason, better thermal response is desired in these thermal recording layers than in thermal recording layers in ordinary thermal recording materials. Japanese Patent Application Laid-Open (JP-A) No. 7-88356 suggests, as a thermal recording material having excellent thermal response, a material using microcapsules wherein walls are made from a specific bifunctional isocyanate compound having in a single molecule thereof two isocyanate groups and a polyfunctional isocyanate compound having in a single molecule thereof three or more isocyanate groups and further a diazonium salt compound is encapsulated.

However, this thermal recording material, which is made from microcapsule-containing composition comprising microcapsules having polyurethane or polyurea walls made by polymerizing a polyfunctional isocyanate compound with a compound having active hydrogen, such as water, has a problem such that when the thermal recording material is stored, the thermal response of the microcapsules changes gradually with the passage of time and the thermal recording sensitivity of the thermal recording material changes accordingly. In order to exhibit excellent color reproduction in multicolor thermal recording material, it is necessary to control the thermal response of microcapsules therein highly, as described above. When the thermal response of the microcapsules is changed by the storage of the recording material, the density of formed color changes so that excellent color reproduction cannot be exhibited.

### SUMMARY OF THE INVENTION

The present invention overcomes the aforementioned problems.

An object of a first invention is to provide a microcapsule-containing composition making it possible to suppress change in the thermal sensitivity of microcapsules with the passage of time and control the thermal response thereof at a high level.

An object of a second invention is to provide a thermal recording material which can suppress change in the thermal recording sensitivity with the passage of time and is excellent in color reproduction.

An object of a third invention is to provide process of preparing a microcapsule-containing composition which can polymerize the microcapsule-containing composition making it possible to suppress change in the thermal sensitivity of microcapsules with the passage of time and control the thermal response thereof at a high level.

The aforementioned objects are solved by the following microcapsule-containing composition and thermal recording material of the invention.

A first aspect of the invention is to provide a microcapsule-containing composition comprising: microcapsules each having a microcapsule wall comprising, as a constituent, at least one selected from polyurethane and polyurea produced by polymerizing a compound having active hydrogen and an isocyanate compound; and a compound of a transition element from Group IV in the long-form Periodic Table.

A second aspect of the invention is to provide a thermal recording material comprising at least one thermal recording layer made from a microcapsule-containing composition comprising microcapsules each having a microcapsule wall comprising, as a constituent, at least one selected from polyurethane and polyurea produced by polymerizing a compound having active hydrogen and an isocyanate compound; and a compound of a transition element from Group IV in the long-form Periodic Table.

A third aspect of the invention is to provide a process of preparing a microcapsule-containing composition comprising the step of: polymerizing a compound having an active hydrogen and an isocyanate compound in the presence of a compound of a transition element from Group IV in the long-form Periodic Table so as to produce microcapsules having a microcapsule wall comprising, as a constituent, at least one selected from polyurethane and polyurea.

### DETAILED DESCRIPTION OF THE INVENTION

<<Microcapsule-Containing Composition>>

The microcapsule-containing composition of the present invention comprises microcapsules each having a microcapsule wall comprising, as a constituent, at least one selected from polyurethane and polyurea produced by polymerizing a compound having active hydrogen and an isocyanate compound (hereinafter referred to as “microcapsules in the invention” on occasion); and further comprises a compound of a transition element from Group IV in the long-form Periodic Table.

In the invention, the aforementioned compound of a transition element from Group IV in the long-form Periodic Table may be encapsulated in the microcapsules, be included in the microcapsule walls, or be included in the microcapsule-containing composition, separately from the microcapsules.

The microcapsule-containing composition of the invention includes the aforementioned compound of a transition element from Group IV in the long-form Periodic Table, whereby change in the thermal sensitivity of the microcapsules with the passage of time can be prevented. Furthermore, the thermal response of the microcapsules can be kept in the state that the thermal response can be controlled at a high level.

The microcapsule-containing composition of the invention can be used in a (multicolor) thermal recording material, a pressure-sensitive recording material, a photo-thermal sensitive recording material, and other recording materials.

The invention is described in detail hereinafter.

The microcapsule-containing composition of the invention comprises a compound of a transition element from Group IV in the long-form Periodic Table, and microcapsules in the invention. If necessary, the microcapsule-containing composition may comprise various additives such as a water-soluble polymer, a latex, and a surfactant.

<Compound of a Transition Element of the Group IV in the Long-Form Periodic Table>

The microcapsule-containing composition of the invention comprises a compound of a transition element from Group IV in the long-form Periodic Table. It is preferable to use, as this compound of a transition element from Group IV in the long-form Periodic Table, either of an oil-soluble compound and a water-soluble compound. The compound of a transition element from Group IV in the long-form Periodic Table may be used in the state that the compound is dispersed in a solid form.

Examples of the compound of a transition element from Group IV in the long-form Periodic Table include zirconium compounds, titanium compounds, and hafnium compounds. zirconium compounds and titanium compounds are preferable, and zirconium compounds are more preferable. Specifically, as the aforementioned compound of a transition element from Group IV in the long-form Periodic Table, preferable is at least one selected from the group consisting of water-soluble zirconium compounds, oil-soluble zirconium compounds, water-soluble titanium compounds and oil-soluble titanium compounds. More preferable are oil-soluble zirconium compounds and oil-soluble titanium compounds.

Preferable examples of the aforementioned water-soluble and oil-soluble zirconium compounds include ZrOCO₃, ZrO(NO₃)₃, ZrOSO₄, ZrO(CH₃COO)₂, (NH₄)₂ZrO(CO₃)₂, Zr(OC₄H₉)₃(C₅H₇O₂), Zr(OC₄H₉)₂(C₅H₇O₂)₂, Zr(OC₄H₉)₃(C₆H₉O₃), Zr(OC₄H₉)(C₅H₇O₂)(C₆H₉O₃)₂, and Zr(OC₄H₉)₃(OCOC₁₇H₃₅), Zr(OC₃H₇)₄, Zr(CH₃COCHCOCH₃)₄, ZrO(C₁₈H₃₅O₂)₂, ZrO(C₁₄H₂₇O₂)₂, ZrO(C₁₂H₂₃O₂)₂ and ZrO(C₈H₁₅O₂)₂.

Preferable examples of the water-soluble and oil-soluble titanium compounds include (OH)₂Ti(C₃H₅O₃)₂, (C₆H₁₄O₃N)₂Ti(C₃H₇O)₂, (C₈H₁₇O)₂Ti(C₈H₁₇O₂)₂, (C₃H₇O)₂Ti(C₆H₉O₃)₂, Ti(C₅H₇O₂)₄, (C₃H₇O)₂Ti(C₅H₇O₂)₂, Ti(OC₃H₇)₄, Ti(OH)₂(OCOC₁₇H₃₅)₂, and Ti(OH)₂(OCOC₁₉H₃₉)₂.

In the microcapsule-containing composition of the invention, the compound of a transition element from Group IV in the long-form Periodic Table may be encapsulated in microcapsules, which will be detailed later, be included in the microcapsule-containing composition, separately from microcapsules, or be included in walls of microcapsules, as described above.

The microcapsule-containing composition of the invention can be produced, for example, by adding a core material, such as a diazonium salt compound, and an isocyanate compound to an organic solvent (oil phase) and then mixing the resultant solution with a water phase containing a compound having active hydrogen and other materials. In the case that the compound of a transition element from Group IV in the long-form Periodic Table is oil-soluble, it is preferable to add the compound of a transition element from Group IV in the long-form Periodic Table to the organic solvent (oil phase). In this case, the compound of a transition element from Group IV in the long-form Periodic Table is encapsulated in microcapsules, or included in microcapsule walls. In the case that the compound of a transition element from Group IV in the long-form Periodic Table is water-soluble, it is preferable to add the compound of a transition element from Group IV in the long-form Periodic Table to the water phase. In this case, the compound of a transition element from Group IV in the long-form Periodic Table is present outside microcapsules. That is, this compound is included in the microcapsule-containing composition, separately from microcapsules.

When the compound of a transition element from Group IV in the long-form Periodic Table is added to the oil phase or the water phase, about the compound of a transition element from Group IV in the long-form Periodic Table which is water-soluble, it is necessary to pay attention to the solution stability thereof, the scope of which includes the reactivity of the compound. About the compound of a transition element from Group IV in the long-form Periodic Table which is oil-soluble, it is necessary to pay attention to the dispersion stability thereof since the compound is added in the form of emulsion.

The content of the compound of a transition element from Group IV in the long-form Periodic Table in the microcapsule-containing composition of the invention is preferably from 0.05% to 20% by mass, more preferably from 0.1% to 10% by mass, most preferably from 0.5% to 5% by mass of the isocyanate compound. When the content of the compound of a transition element from Group IV in the long-form Periodic Table ranges from 0.05% to 20% by mass, coloration and aggregation of microcapsules can be prevented without lowering the effect of the suppressing the thermal recording sensitivity.

<Microcapsules>

The microcapsules in the invention have a microcapsule wall comprising, as a constituent, at least one selected from polyurethane and polyurea formed by polymerizing a compound having active hydrogen and an isocyanate compound. Hereinafter, the wording “microcapsule wall comprising, as a constituent, at least one selected from polyurethane and polyurea” may be referred to as “polyurethane/polyurea wall”. The microcapsules in the invention having the polyurethane/polyurea wall, which is formed by polymerizing an isocyanate and a compound having active hydrogen in this way, have properties that the microcapsules have high thermal sensitivity, exhibit high color formation efficiency when they include a color forming component, and are also excellent in unprocessed stock storability (shelf life).

The isocyanate compound which can be used in the aforementioned reaction may be a polyfunctional isocyanate compound having, in the molecule thereof, two or more functional groups. Examples of the compound having, in the molecule thereof, two functional groups include m-phenylenediisocyanate, p-phenylenediisocyanate, 2,6-tolylenediisocyanate, 2,4-tolylenediisocyanate, naphthalene-1,4-diisocyanate, diphenylmethane-4,4′-diisocyanate, 3,3′-dimethoxy-biphenyldiisocyanate, 3,3′-dimethyldiphenylmethane-4,4′-diisocyanate, xylylene-1,4-diisocyanate, xylylene-1,3-diisocyanate, 4-chloroxylylene-1,3-diisocyanate, 2-methylxylylene-1,3-diisocyanate, 4,4′-diphenylpropanediisocyanate, 4,4′-diphenylhexafluoropropanediisocyanate, trimethylenediisocyanate, hexamethylenediisocyanate, propylene-1,2-diisocyanate, butylene-1,2-diisocyanate, cyclohexylene-1,2-diisocyanate, cyclohexylene-1,3-diisocyanate, cyclohexylene-1,4-diisocyanate, dicyclohexylmethane-4,4′-diisocyanate, 1,4-bis(isocyanatemethyl)cyclohexane, 1,3-bis(isocyanatemethyl)cyclohexane, isophoronediisocyanate, and lysinediisocyanate. Addition reaction products made from any one of these bifunctional isocyanate compounds and any one of bifunctional alcohols and phenols, such as ethylene glycols and bisphenols, can be used.

Examples of the compound having, in the molecule thereof, three or more isocyanate groups include trimers of the aforementioned bifunctional isocyanate compound as main starting material (i.e., biurets or isocyanurates); polyfunctional adducts made from a polyol, such as trimethylolpropane, and a bifunctional isocyanate compound; polymers made from an isocyanate compound having a polymerizable group, such as a formalin condensate of benzeneisocyanate or methacryloyloxyethylisocyanate; and lysine triisocyanate. Particularly preferable are trimers of xylenediisocyanate and hydrogenated xylenediisocyanate, hexamethylenediisocyanate, or tolylenediisocyanate and hydrogenated tolylenediisocyanate as main starting material(s) (i.e., biurets or isocyanurates), and polyfunctional adducts thereof with trimethylolpropane. These compounds are described in “Polyurethane Resin Handbook” (edited by Keiji Iwata and published by the Nikkan Kogyo Shimbun, Ltd. in 1987).

Among these examples, preferable are 2,4-tolylenediisocyanate; 2,6-tolylenediisocyanate; xylylene-1,4-diisocyanate; xylylene-1,3-diisocyanate; an adduct made from trimethylolpropane and xylylene-1,4-diisocyanate or xylylene-1,3-diisocyanate. Particularly preferable are xylylene-1,4-diisocyanate; xylylene-1,3-diisocyanate; and an adduct made from trimethylolpropane and xylylene-1,4-diisocyanate or xylylene-1,3-diisocyanate.

These isocyanate compounds may be used alone or in the form of a mixture of two or more thereof.

Polymerization of the isocyanate compound in the invention with the compound having an active hydrogen atom is conducted, for example, by reaction thereof with a compound having in the molecule thereof two or more active hydrogen atoms. Examples of such a compound having an active hydrogen atom include water; polyhydric alcohols such as ethylene glycol and glycerin; polyhydric amine compounds such as ethylenediamine and diethylenetriamine; and mixtures thereof. It is preferable to use water, out of these examples, so as to conduct the polymerization. As a result, polyurethane/polyurea walls are formed.

The microcapsule-containing composition of the invention can be produced by a method which is appropriately selected from known microcapsule-forming methods.

For example, the microcapsule-containing composition of the invention can be prepared according to the following process. The process comprising the step of, polymerizing a compound having an active hydrogen and an isocyanate compound in the presence of a compound of a transition element from Group IV in the long-form Periodic Table so as to produce microcapsules having a microcapsule wall comprising, as a constituent, at least one selected from polyurethane and polyurea.

Specifically, interfacial polymerization or inner polymerization is suitable. Details of the aforementioned capsule-forming methods and specific examples of reactants therein are described in U.S. Pat. Nos. 3,726,804 and 3,796,669. In the case that polyurea or polyurethane is used as capsule wall material, polyisocyanate and a second material which reacts with polyisocyanate to form capsule walls (for example, polyol or polyamine) are first incorporated into an aqueous medium or an oil medium which should be encapsulated. Next, these components are emulsified in water, and subsequently the emulsion is heated to cause polymer-forming reaction on the surfaces of the oil droplets, thereby forming microcapsule walls. When the addition of the aforementioned second material is omitted, polyurea can be produced as well.

As the core material of the microcapsules in the invention, a diazonium salt compound, an electron donating colorless dye, or the like can be used. The following describes a process for producing the microcapsule-containing composition (polyurethane/polyurea walls) of the invention using a diazonium salt as the core material.

First, a diazonium salt is dissolved or dispersed in a hydrophobic organic solvent, which becomes capsule cores, so as to prepare an oil phase which becomes the microcapsule cores. At this time, the compound of a transition element from Group IV in the long-form Periodic Table and the aforementioned isocyanate compound as a wall material are added thereto.

At the time of preparing the oil phase, it is preferable to use an organic solvent having a boiling point of 100° C. to 300° C. as the hydrophobic organic solvent, which is used to form the microcapsule cores, wherein the diazonium salt is dissolved or dispersed. Examples of the organic solvent include alkylnaphthalene, alkyldiphenylethane, alkyldiphenylmethane, alkylbiphenyl, alkylterphenyl, chlorinated paraffin, phosphates, maleates, adipates, phthalates, benzoates, carbonates, ethers, sulfates, and sulfonates. These may be used alone or in the form of a mixture of two or more thereof.

In the case that the solubility of the diazonium salt to be encapsulated in the organic solvent is poor, it is allowable to use, as an auxiliary solvent, a low boiling point solvent in which the used diazonium salt is highly dissolved. Examples of the low boiling point solvent include ethyl acetate, propyl acetate, isopropyl acetate, butyl acetate, methylene chloride, tetrahydrofuran, acetonitrile, and acetone.

It is therefore preferable that the diazonium salt has an appropriate solubility in the high boiling point organic solvent and the low boiling point solvent. Specifically, the solubility of the diazonium salt in the solvents is preferably 5% or more. The solubility of the diazonium salt in water is preferably 1% or less.

As the water phase, an aqueous solution wherein a water-soluble polymer is dissolved is used. The aforementioned oil phase is incorporated into the water phase, and subsequently the aforementioned compound having an active hydrogen atom is added thereto. The mixture is emulsified by such means as a homogenizer, whereby a microcapsule-containing composition can be prepared. The water-soluble polymer acts as a dispersing medium for making the emulsification uniform and easy and further making the emulsified solution stable. In order to make the emulsified solution more uniform and stable, a surfactant may be added to one selected from the oil phase and the water phase. As the surfactant, a known surfactant for emulsification may be used. When the surfactant is added, the amount thereof is preferably from 0.1% to 5% by mass, more preferably from 0.5% to 2% by mass of the oil phase.

The water-soluble polymer used in the water-soluble polymer aqueous solution, wherein the prepared oil phase is dispersed, is preferably a water-soluble polymer the solubility of which in water is 5% or more at a temperature at which the emulsification is performed. Examples of the water-soluble polymer include polyvinyl alcohol and modified products thereof, polyacrylic amide and derivatives thereof, ethylene/vinyl acetate copolymer, styrene/maleic anhydride copolymer, ethylene/maleic anhydride copolymer, isoprene/maleic anhydride copolymer, polyvinyl pyrrolidone, ethylene/acrylic acid copolymer, vinyl acetate/acrylic acid copolymer, carboxymethylcellulose, methylcellulose, casein, gelatin, starch derivatives, gum arabic, and sodium alginate.

It is preferable that the water-soluble polymer has no reactivity with the isocyanate compound or a low reactivity therewith. For example, about a polymer having a reactive amino group in the molecular chain thereof, such as gelatin, it is preferable that the reactivity thereof is removed by modifying the polymer in advance.

In the case that the microcapsules are used in thermal recording material, the amount of the used isocyanate compound is preferably decided in such a manner that the average particle size of the microcapsules will be from 0.3 μm to 12 μm and the wall thickness thereof will be from 0.001 μm to 0.3 μm. The dispersion particle size thereof is generally from about 0.2 μm to 10 μm.

In the emulsion wherein the oil phase is added to the water phase, polymerization reaction of the polyhydric isocyanate is generated in the interface between the oil phase and the water phase, so as to form polyurea walls.

When at least one of polyol and polyamine is further added to the water phase or the hydrophobic solvent of the oil phase, the added component reacts with the polyhydric isocyanate and can be used as one of the constituents of the microcapsule walls. In order to make the reaction speed large, it is preferable to keep reaction temperature in this reaction high and add an appropriate polymerization catalyst.

Specific examples of the polyol or polyamine include propylene glycol, glycerin, trimethylolpropane, triethanolamine, sorbitol and hexamethylenediamine. When the polyol is added, polyurethane walls are formed.

Details of polyhydric isocyanate compounds, polyol, reaction catalysts, polyamine which constitutes a part of the wall material, and others are described in published documents (“Polyurethane Handbook” edited by Keiji Iwata and published by the Nikkan Kogyo Shimbun, Ltd. in 1987).

The aforementioned emulsification can be performed by means of an appropriately-selected known emulsifying machine, such as a homogenizer, a Manton-Gaulin, an ultrasonic disperser, a dissolver, or a Kdmill. After the emulsification, the emulsion is heated up to a temperature of 30° C. to 70° C. in order to promote capsule wall forming reaction. In order to prevent the aggregation of the capsules, it is necessary to add water to the reaction system so as to lower the probability of collision between the capsules, or perform sufficient stirring or some other operation during the reaction.

During the reaction, dispersion for preventing the aggregation may newly be added. The generation of carbon dioxide, following the advance of the polymer reaction, is observed. The end thereof can be substantially regarded as the end point of the capsule wall forming reaction. Usually, the target diazonium salt-encapsulating microcapsules can be obtained by continuing the reaction for several hours.

<<Thermal Recording Material>>

The thermal recording material of the invention has a thermal recording layer made from the aforementioned microcapsule-containing composition of the invention. In this case, it is preferable that a diazonium salt compound is encapsulated, as a core material, into the microcapsules of the invention.

The following describes the thermal recording material of the invention.

<Thermal Recording Layer>

The thermal recording layer in the invention is designed to contain a color forming component and make it possible to form a desired color image by color forming reaction of the color forming component. As the color forming component, a known color forming component, the kind of which is not particularly limited, can be suitably used. Preferable examples of the color forming reaction include color forming reaction between a diazonium salt compound and a coupler, and color forming reaction between an electron donating colorless dye and an electron accepting compound.

(Diazonium Salt Compound)

In the case that the thermal recording layer contains the diazonium salt compound and the coupler, which reacts with the diazonium salt compound thermally to form a color, it is preferable to add to the thermal recording layer a basic material for promoting color forming reaction between the diazonium salt compound and the coupler.

The diazonium salt compound is represented by the following general formula (A):

Ar—N₂⁺X⁻ General formula (A)

wherein Ar represents an aryl group, and X represents an acidic anion. This compound is a compound capable of controlling the maximum absorption wavelength thereof by the position of the substituent of the Ar position or the kind thereof.

Specific examples of the diazonium salt compound include acidic anion salts such as 4-(N-(2-(2,4-di-tert-amylphenoxy)butylyl)piperazino)benzene diazonium, 4-dioctylaminobenzene diazonium, 4-(N-(2-ethylhexanoyl)piperazino)benzene diazonium, 4-dihexylamino-2-hexyloxybenzene diazonium, 4-N-ethyl-N-hexadecylamino-2-ethoxybenzo diazonium, 3-chloro-4-dioctylamino-2-octyloxybenzene diazonium, 2,5-dibutoxy-4-morpholinobenzene diazonium, 2,5-octoxy-4-morpholinobenzene diazonium, 2,5-dibutoxy-4-(N-(2-ethylhexanoyl)piperazino)benzenediazonium, 2,5-diethoxy-4-(N-(2-(2,4-di-tert-amylphenoxy)butylyl)piperazino)benzene diazonium, 2,5-dibutoxy-4-tolylthiobenzene diazonium, and 3-(2-octyloxyethoxy)-4-morphlinobenzene diazonium; and the following diazonium salt compounds (D-1 to D-5):

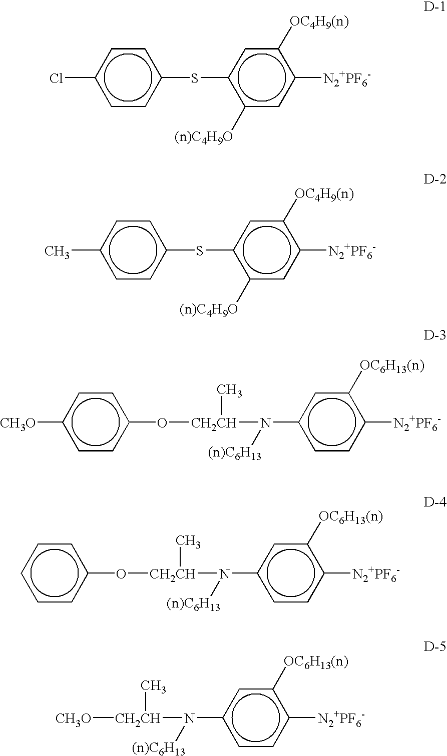

Among these compounds, hexafluorophosphate salts, tetrafluoroborate salts, and 1,5-naphthalenesulfonate salts are particularly preferable.

Among these diazonium salt compounds, particularly preferable are 4-(N-(2-(2,4-di-tert-amylphenoxy)butylyl)piperazino)benzene diazonium, 4-dioctylaminobenzene diazonium, 4-(N-(2-ethylhexanoyl)piperazino)benzene diazonium, 4-dihexylamino-2-hexyloxybenzene diazonium, 4-N-ethyl-N-hexadecylamino-2-ethoxybenzo diazonium, 2,5-dibutoxy-4-(N-(2-ethylhexanoyl)piperazino)benzene diazonium, 2,5-diethoxy-4-(N-(2-(2,4-di-tert-amylphenoxy)butylyl)piperazino)benzene diazonium, and the diazonium salt compounds (D-3 to D-5), which are photolyzed by light having a wavelength of 300 nm to 400 nm.

The maximum absorption wavelength of the diazonium salt compound referred to herein is a maximum absorption wavelength obtained by measuring a coating, which is obtained by applying each of the diazonium compounds to a support in an application amount (i.e., coating amount) of 0.1 g/m² to 1.0 g/m², with a spectrophotometer (trade name: MPS-2000, manufactured by Shimadzu Mfg. Co.).

The aforementioned diazonium salt compound may be in an oily form or in a crystalline form. The diazonium salt compound is preferably a compound in a crystalline form at ambient temperature since the compound is easy to handle. The diazonium salt compounds may be used alone or in combination of two or more thereof.

The content of the diazonium salt compound in the thermal recording layer is preferably from 0.02 g/m² to 5 g/m², and is more preferably from 0.1 g/m² to 4 g/m² from the viewpoint of the density of formed color.

Zinc chloride, cadmium chloride, tin chloride or the like may be used to form a complex compound, whereby the diazonium salt can be made stable.

As described above, the thermal recording material of the invention preferably has at least one thermal recording layer containing the diazonium salt compound encapsulated in the microcapsules in the invention.

(Coupler)

Examples of the coupler, which reacts with the diazonium salt compound thermally to form a color, include resorcin, phloroglucin, sodium 2,3-dihydroxynaphthalene-6-sulfonate, 1-hydroxy-2-naphthoic morphlinopropylamide, 1,5-dihydroxynaphthalene, 2,3-dihydroxynaphthalene, 2,3-dihydroxy-6-sulfanylnaphthalene, 2-hydroxy-3-naphthoic anilide, 2-hydroxy-3-naphthoic ethanolamide, 2-hydroxy-3-naphthoic octylamide, 2-hydroxy-3-naphthoic acid-N-dodecyloxypropylamide, 2-hydroxy-3-naphthoic tetradecylamide, acetoanilide, acetoacetoanilide, benzoylacetoanilide, 2-chloro-5-octylacetoacetoanilide, 1-phenyl-3-methyl-5-pyrrazolone, 1-(2′-octylphenyl)-3-methyl-5-pyrrazolone, 1-(2′,4′,6′-trichlorophenyl)-3-benzamide-5-pyrrazolone, 1-(2′,4′,6′-trichlorophenyl)-3-anilino-5-pyrrazolone, 1-phenyl-3-phenylacetoamide-5-pyrrazolone, and compounds represented by the following C-1 to C-6:

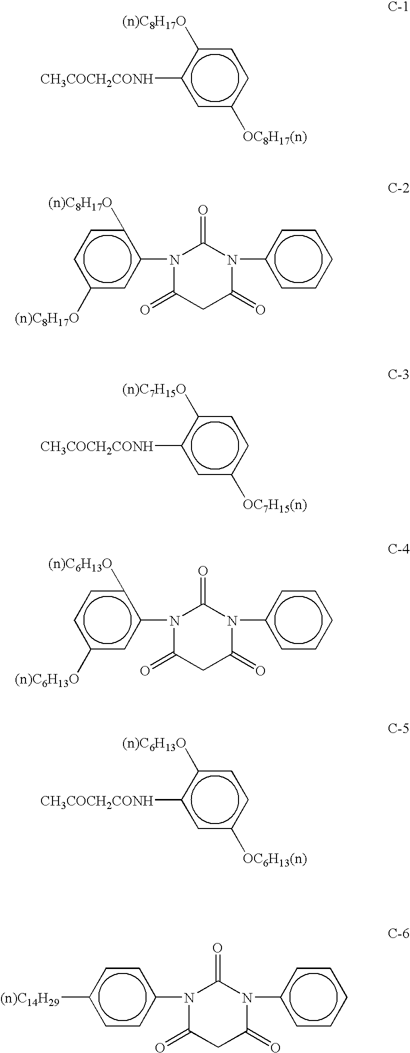

These couplers may be used alone or in combination of two or more thereof.

The coupler may also be used in the state that the coupler is dispersed, together with a water-soluble polymer, an organic base, a color forming auxiliary and so on, into a solid form with a sand mill or the like.

Particularly preferable is an embodiment wherein the coupler is dissolved into a high boiling point organic solvent which is slightly soluble or insoluble in water; the resultant solution is mixed with a polymer aqueous solution (water phase) containing one selected from a surfactant and a water-soluble polymer as a protective colloid; the mixture is emulsified with a homogenizer or the like; and the resultant emulsion is used. In this case, a low boiling point solvent may be used as a dissolution auxiliary if necessary. Furthermore, the coupler and the organic base may be emulsified or dispersed separately from each other, or mixed with each other and dissolved in the high boiling point organic solvent so as to be emulsified. The particle size of the emulsion is preferably 1 μm or less.

The amount of the used coupler is preferably from 0.1 to 30 parts by mass per 1 part by mass of the diazonium salt.

The high boiling point organic solvent used in this case can be appropriately selected, for example, from high boiling point oils described in JP-A No. 2-141279. From the viewpoint of the emulsification stability of the emulsion, as the high boiling point organic solvent, esters are preferable and tricresyl phosphate is particularly preferable. The oils may be used in combination, or any one of the oils may be used together with some other oil.

An auxiliary solvent having a low boiling point may be added, as a dissolution auxiliary, to the high boiling point organic solvent. Preferable examples of the auxiliary solvent include ethyl acetate, isopropyl acetate, butyl acetate and methylene chloride. As the case may be, only the low boiling point auxiliary solvent may be used without using any high boiling point organic solvent.

The water-soluble polymer, which is incorporated as a protective colloid into the water phase, may be appropriately selected from known anionic polymers, nonionic polymers, and amphoteric polymers. Particularly preferable examples of the water-soluble polymer include polyvinyl alcohol, gelatin and cellulose derivatives.

The surfactant, which is incorporated into the water phase, may be appropriately selected from anionic and nonionic surfactants which do not act onto the aforementioned protective colloid not to cause precipitation or aggregation. Examples of the surfactant include sodium alkylbenzenesulfonates, sodium alkylsulfates, sodium dioctyl sulfosuccinate, and polyalkylene glycols (such as polyoxyethylene nonylphenyl ether).

(Electron Donating Colorless Dye)

The electron donating colorless dye, the kind of which is not particularly limited, can be appropriately selected from known electron donating colorless dyes dependently on purpose. In the invention, an electron donating colorless dye precursor may be used.

Examples of the electron donating colorless dye precursor include triarylmethane compounds, diphenylmethane compounds, thiazine compounds, xanthene compounds, and spiropyran compounds. These may be used alone or in combination of two or more thereof. Among these examples, triarylmethane compounds and xanthene compounds are preferable since they exhibit high density of formed color so as to be useful. Examples of the electron donating colorless dye precursor include 3,3-bis(p-dimethylaminophenyl)-6-dimethylaminophthalide (that is, Crystal Violet Lactone), 3,3-bis(p-dimethylamino)phthalide, 3-(p-dimethylaminophenyl)-3-(1,3-dimethylindole-3-yl)phthalide, 3-(p-dimethylaminophenyl)-3-(2-methylindole-3-yl)phthalide, 3-(o-methy-p-diethylaminophenyl)-3-(2-methylindole-3-yl)phthalide, 4,4′-bis(dimethylamino)benzhydrine benzyl ether, N-halophenyl leuco Auramine, N-2,4,5-trichlorophenyl leuco Auramine, rhodamine-B-anilinolactam, Rhodamine (p-nitroanilino)lactam, Rhodamine-B-(p-chloroanilino)lactam, 2-benzylamino-6-diethylaminofluorane, 2-anilino-6-diethylaminofluorane, 2-anilino-3-methyl-6-diethylaminofluorane, 2-anilino-3-methyl-6-cyclohexylmethylaminofluorane, 2-anilino-3-methyl-6-isoamylethylaminofluorane, 2-(o-chloroanilino)-6-diethylaminofluorane, 2-octylamino-6-diethylaminofluorane, 2-ethoxyethylamino-3-chloro-2-diethylaminofluorane, 2-anilino-3-chloro-6-diethylaminofluorane, benzoyl leuco Methylene Blue, p-nitrobenzyl leuco Methylene Blue, 3-methyl-spiro-dinaphthopyran, 3-ethyl-spiro-dinaphthopyran, 3,3′-dichloro-spiro-dinaphthopyran, 3-benzylspirodinaphtopyran, and 3-propyl-spiro-dibenzopyran.

The content of the electron donating colorless dye in the thermal recording layer is preferably from 0.05 g/m² to 5 g/m² and is more preferably from 0.1 g/m² to 4 g/m² from the viewpoint of the density of formed color.

(Electron Accepting Compound)

The electron accepting compound, the kind of which is not particularly limited, can be appropriately selected from known electron accepting compounds dependently on purpose. Examples of the electron accepting compound include phenol derivatives, salicylic acid derivatives, and hydroxybenzoic acid esters. Among these examples, bisphenols and hydroxybenzoic acid esters are particularly preferable as the electron accepting compound. Specifically, particularly preferable examples thereof include 2,2-bis(p-hydroxyphenyl)propane (that is, bisphenol A), 4,4′-(p-phenylenediisopropylidene)diphenol (that is, bisphenol P), 2,2-bis(p-hydroxyphenyl)pentane, 2,2-bis(p-hydroxyphenyl)ethane, 2,2-bis(p-hydroxyphenyl)butane, 2,2-bis(4′-hydroxy-31,5′-dichlorophenyl)propane, 1,1-(p-hydroxyphenyl)cyclohexane, 1,1-(p-hydroxyphenyl)propane, 1,1-(p-hydroxyphenyl)pentane, 1,1-(p-hydroxyphenyl)-2-ethylhexane, 3,5-di(α-methylbenzyl)salycyclic acid and polyvalent metal salts thereof, 3,5-di(tert-butyl)salicylic acid and polyvalent metal salts thereof, 3-α,α-dimethylbenzylsalicyclic acid and polyvalent metal salts thereof, butyl p-hydroxybenzoate, benzyl p-hydroxybenzoate, 2-ethylhexyl p-hydroxybenzoate, p-phenylphenol, and p-cumylphenol.

The content of the electron accepting compound in the thermal recording layer is preferably from 0.1 g/m² to 50 g/m², and is more preferably from 0.5 g/m² to 40 m²/g from the viewpoint of the density of formed color.

(Organic Base)

About the thermal recording material of the invention, an embodiment wherein an organic base is added as a basic material in order to promote coupling reaction between the diazonium salt and the coupler is preferable.

Examples of the organic base include nitrogen-containing compounds such as tertiary amines, piperidines, piperazines, amidines, formamidines, pyridines, guanidines, and morpholines. Preferable examples of the organic base include compounds described in Japanese Patent Application Publication (JP-B) No. 52-46806, JP-A Nos. 62-70082, 57-169745, 60-94381, 57-123086, 60-49991, JP-B Nos. 2-24916 and 2-28479, JP-A Nos. 60-165288 and 57-185430. These compounds may be used alone or in combination of two or more thereof.

Among the aforementioned compounds, specifically, the following are preferable as the organic base: piperazines such as N,N′-bis(3-phenoxy-2-hydroxypropyl)piperazine, N,N′-bis[3-(p-methylphenoxy)-2-hydroxypropyl]piperazine, N,N′-bis[3-(p-methoxyphenoxy)-2-hydroxypropyl]piperazine, N,N′-bis(3-phenylthio-2-hydroxypropyl)piperazine, N,N′-bis[3-(β-naphthoxy)-2-hydroxypropyl]piperazine, N-3-(β-naphthoxy)-2-hydroxypropyl-N′-methylpiperazine, 1,4-bis{[3-(N-methylpiperazino)-2-hydroxy]propyloxy}benzene; morpholines such as N-[3-(β-naphthoxy)-2-hydroxy]propylmorpholine, 1,4-bis(3-morpholino-2-hydroxy-propyloxy)benzene, and 1,8-bis(3-morpholino-2-hydroxy-propyloxy)benzene; piperidines such as N-(3-phenoxy-2-hydroxypropyl)piperidine, and N-dodecylpiperidine; and guanidines such as triphenylguanidine, tricyclohexylguanidine and dicyclohexylphenylguanidine.

The amount of the used organic base is preferably from 0.1 to 30 parts by mass per 1 part by mass of the diazonium compound.

When this used amount is within the range of 0.1 to 30 parts by mass, sufficient density of formed color can be obtained and the decomposition-promotion of the diazo salt compound can be prevented.

(Color Forming Auxiliary)

It is allowable to incorporate, into the thermal recording layer, a color forming auxiliary besides the organic base in order to promote color forming reaction, that is, in order to thermal print an image promptly and completely with a low energy. The color forming auxiliary is a substance which makes the density of formed color high or controls color forming temperature at the time of thermal recording. The color forming auxiliary is a material for putting the coupler, the basic material, the diazonium salt and so on into conditions that they react easily by lowering the melting points of these materials or lowering the softening point of capsule walls.

Examples of the color forming auxiliary include phenol derivatives, naphthol derivatives, alkoxy-substituted benzene compounds, alkoxy-substituted naphthalene compounds, aromatic ethers, thioethers, esters, amides, ureides, urethanes, sulfonamide compounds, and hydroxy compounds.

The color forming auxiliary contains a thermally meltable material. The thermally meltable material is a material which has a melting point of 50° C. to 150° C., is in a solid form at ambient temperature and is melted by heat. The thermally meltable material is also a material in which the diazonium salt, the coupler, the organic base or the like can be dissolved. Specifically, examples of the thermally meltable material include carboxylic acid amides, N-substituted carboxylic acid amides, ketone compounds, urea compounds, and esters.

(Antioxidant)

In order to improve the fastness of thermally-formed color images against light and heat in the thermal recording material of the invention or reduce the yellowing of non-printed portions (non-image portions) by light after the images are fixed, it is also preferable to use the following known antioxidants.

The antioxidants are described in, for example, EP Laid-Open Nos. 223739, 309401, 309402, 310551, 310552 and 459416, DE Laid-Open No. 3435443, JP-A Nos. 54-48535, 62-262047, 63-113536, 63-163351, 2-262654, 2-71262, 3-121449, 5-61166 and 5-119449, and U.S. Pat. Nos. 4,814,262 and 4,980,275.

It is also effective to use known various additives which have already been used in thermal recording material or pressure-sensitive recording material.

Examples of the various additives include compounds described in JP-A Nos. 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 63-051174, 63-89877, 63-88380, 63-088381, 63-203372, 63-224989, 63-251282, 63-267594, 63-182484, 1-239282, 4-291685, 4-291684, 5-188687, 5-188686, 5-110490 and 5-170361, and JP-B Nos. 48-043294 and 48-033212.

Specific examples of the various additives include 6-ethoxy-1-phenyl-2,2,4-trimethyl-1,2-dihydroquinoline, 6-ethoxy-1-octyl-2,2,4-trimethyl-1,2-dihydroquinoline, 6-ethoxy-1-phenyl-2,2,4-trimethyl-1,2,3,4-tetrahydroquinoline, 6-ethoxy-1-octyl-2,2,4-trimethyl-1,2,3,4-tetrahydroquinoline, nickel cyclohexanoate, 2,2-bis(4-hydroxyphenyl)propane, 1,1-bis(4-hydroxyphenyl)-2-ethylhexane, 2-methyl-4-methoxy-diphenylamine, and 1-methyl-2-phenylindole.

The amount of each of the antioxidant and the various additives is preferably from 0.05 to 100 parts by mass, and is more preferably from 0.2 to 30 parts by mass per 1 part by mass of the diazonium salt.

The antioxidant and the various additives may be incorporated, together with the diazonium salt, into microcapsules. These may be incorporated in the form of solid dispersion, together with the coupler, the basic material and the color forming auxiliary. These may be incorporated in the form of emulsion, together with an appropriate emulsification auxiliary. These may be incorporated in the form of the two. The antioxidant and the various additives may be used alone or in combination. These may be incorporated into a protective layer.

The antioxidant and the various additives are not necessarily added to the same layer.

In the case that the antioxidant and the various additives are used in combination, it is allowable that they are structurally classified into anilines, alkoxybenzenes, hindered phenols, hindered amines, hydroquinone derivatives, phosphorus compound and sulfur compounds and then compounds having different structures, out of these compounds, are combined or compounds having the same structure are combined.

(Free Radical Generating Agent)

In order to decrease the yellowing of the background portion of the thermal recording material of the invention after images are recorded, it is allowable to add a free radical generating agent (compound which generates free radicals by irradiation with light), which is used in photopolymerizable compositions or the like.

Examples of the free radical generating agent include aromatic ketones, quinones, benzoin, benzoin ethers, azo compounds, organic disulfides and acyloxime esters.

The amount of the added free radical generating agent is preferably from 0.01 to 5 parts by mass per 1 part by mass of the diazonium compound.

(Vinyl Monomer)

In order to decrease the yellowing in the same way, it is allowable to use a polymerizable compound having an ethylenical unsaturated bond (hereinafter referred to as “vinyl monomer”). The vinyl monomer is a compound having, in the chemical structure thereof, at least one ethylenical unsaturated bond (vinyl group, vinylidene group or the like). The vinyl monomer is in a chemical form of a monomer or a prepolymer.

Examples of the vinyl monomer include unsaturated carboxylic acids and salts thereof, esters made from an unsaturated carboxylic acid and an aliphatic polyhydric alcohol, and amides made from an unsaturated carboxylic acid and an aliphatic polyhydric amine compound. The vinyl monomer can be used in a ratio of 0.2 to 20 parts by mass per 1 part by mass of the diazonium salt.

The free radical generating agent or the vinyl monomer can be used in the state that this component is incorporated together with the diazonium salt into microcapsules.

As an acid stabilizer, citric acid, tartaric acid, oxalic acid, boric acid, phosphoric acid, pyrophosphoric acid or the like can be used.

(Structure of Layer)

The thermal recording layer is preferably an embodiment wherein the aforementioned organic base is contained.

The method for applying the thermal recording layer can be appropriately selected from known coating methods. The coating methods are, for example, bar coating, blade coating, air knife coating, gravure coating, roll coating, spray coating, dip coating, and curtain coating.

The amount of the thermal recording layer after being applied and dried, that is, the amount of the thermal recording layer applied and dried is preferably from 2.5 g/m² to 30 g/m².

The structural embodiment of the thermal recording layer is not particularly limited. For example, the thermal recording layer may be an embodiment made of a single layer containing all of microcapsules, the coupler, the organic base and so on, or an embodiment composed of plural layers each of which contains any one of them separately. The thermal recording material may be an embodiment wherein an intermediate layer described in Japanese Patent Application No. 59-177669 is deposited on a support and then the thermal recording layer is applied onto the intermediate layer.

As will be described later, the thermal recording material may be an embodiment of a full color forming type, wherein plural layers having color hues different from each other, each of the layers being capable of forming only a single color, are laminated.

(Binder)

In the thermal recording material of the invention, each of the thermal recording layer, the intermediate layer, a protective layer, which will be detailed later, and other layers may contain a binder. The binder may be appropriately selected from known water-soluble polymer compounds and latexes.

Examples of the water-soluble polymer compounds include methylcellulose, carboxymethylcellulose, hydroxyethylcellulose, hydroxypropylcellulose, starch derivatives, casein, gum arabic, gelatin, ethylene/maleic anhydride copolymer, styrene/maleic anhydride copolymer, polyvinyl alcohol, silanol-modified polyvinyl alcohol, carboxyl-modified polyvinyl alcohol, epichlorohydrin-modified polyamide, isobutylene/maleic anhydride salicylic acid copolymer, polyacrylic acid, polyacrylic acid amide, and modified products thereof.

Examples of the latexes include styrene/butadiene rubber latex, methyl acrylate/butadiene rubber latex, and vinyl acetate emulsion.

Among the aforementioned examples, hydroxyethylcellulose, starch derivatives, gelatin, polyvinyl alcohol derivatives, and polyacrylic acid amide derivatives are preferable as the binder.

A pigment may be incorporated into the thermal recording material. The pigment may be a known organic or inorganic pigment. Examples of the pigment include kaolin, fired kaolin, talc, agalmatolite, diatomaceous earth, calcium carbonate, aluminum hydroxide, magnesium hydroxide, zinc oxide, lithopone, amorphous silica, colloidal silica, fired gypsum, silica, magnesium carbonate, titanium oxide, alumina, barium carbonate, barium sulfate, mica, microballoon, urea/formalin filler, polyester particles, and cellulose filler.

If necessary, it is allowable to use known additives such as a wax, an antistatic agent, an antifoaming agent, an electrically conductive agent, a fluorescent dye, a surfactant, an ultraviolet ray absorber, and precursors thereof.

<Protective Layer>

If necessary, a protective layer may be deposited on the thermal recording layer in the thermal recording material. Two or more protective layers may be deposited if necessary.

Examples of material used for the protective layer include water-soluble polymer compounds such as polyvinyl alcohol, carboxy-modified polyvinyl alcohol, vinyl acetate/acrylamide copolymer, silicon-modified polyvinyl alcohol, starch, modified starch, methylcellulose, carboxymethylcellulose, hydroxymethylcellulose, gelatins, gum arabic, casein, styrene/maleic acid copolymer hydrolyzate, styrene/maleic acid copolymer half-ester hydrolyzate, isobutylene/maleic anhydride copolymer hydrolyzate, polyacrylamide derivatives, polyvinyl pyrrolidone, sodium polystyrenesulfonate, and sodium alginate; and latexes such as styrene/butadiene rubber latex, acrylonitrile/butadiene rubber latex, methyl acrylate/butadiene rubber latex, and vinyl acetate emulsion.

The storage stability of the thermal recording material can be further improved by crosslinking the water-soluble polymer compound in the protective layer with a crosslinking agent. The crosslinking agent can be appropriately selected from known crosslinking agents. Examples of the crosslinking agent include water-soluble initial condensates such as N-methylolurea, N-methylolmelamine, and urea/formalin; dialdehyde compounds such as glyoxal, and glutaraldehyde; inorganic crosslinking agents such as boric acid and borax; and polyamide epichlorohydrin.

In the protective layer, a known pigment, metal soap, wax, surfactant or the like can be further used.

The amount of the protective layer applied and dried is preferably from 0.2 g/m² to 5 g/m², more preferably from 0.5 g/m² to 2 g/m². The film thickness thereof is preferably from 0.2 μm to 5 μm, more preferably from 0.5 μm to 2 μm.

In the case that the protective layer is formed, a known ultraviolet ray absorber or a precursor thereof may be incorporated into this protective layer.

The protective layer can be formed by the aforementioned known coating method in the same way as in the case of forming the thermal recording layer on a support.

<Support>

A support which can be used in the thermal recording material may be any one of paper supports used in ordinary pressure-sensitive paper, thermosensitive paper, and dry or wet type diazo copying paper. Examples of the support which can be used include acidic paper, neutral paper, coated paper, plastic film laminated paper, synthetic paper, and plastic films such as polyethylene terephthalate and polyethylene naphthalate films.

In order to amend the curl balance of the thermal recording material or improve the resistance thereof against chemicals from the back face, a back coat layer may be formed on the support. The back coat layer may be formed in the same way as the protective layer.

If necessary, an antihalation layer may be formed between the support and the thermal recording layer or on the support surface of the side where the thermal recording layer is formed. A slipping layer, an antistatic layer, an adhesive agent layer or some other layer may be formed on the support surface of the side opposite to the aforementioned side.

A peeling paper can be laminated, through an adhesive layer, on the rear face of the support (i.e., on the support surface of the side where no thermal recording layer is formed), so as to form a label.

As described above, a high density of formed color can be obtained and further an image can be light-fixed at a high speed by using, in the thermal recording layer, the diazonium salt compound encapsulated in the microcapsules in the invention. By making the light fixing speed large in this way, the time for recording can be shortened. Moreover, sufficient fixing effect can be expected since the diazonium salt itself has excellent decomposing ability. Accordingly, a fall in the whiteness, based on coloration of the non-image portion (background portion), can be prevented. A highly contrast image, which is small in image-density change, can be obtained. That is, both of improvement in the stability for recording material and high-speed recording can be realized.

Additionally, the long-term stability of the recording material can be made higher by encapsulating the diazonium salt in microcapsules.

<Image Forming Method>

The formation of an image using the thermal recording material may be performed by the following method.

First, the surface of the thermal recording material of the side where the thermal recording layer is formed is imagewise heated by means of a heating device such as a thermal head and an image is printed. In this way, in the heated portion of the thermal recording layer, capsule walls containing polyurea or polyurethane in the layer soften so as to become material-transmissible. The coupler and the basic material (organic base) outside the capsules enter the microcapsules, so that a color is imagewise formed to form an image.

In this case, by radiating light having a wavelength corresponding to an absorption wavelength of the diazonium salt onto the recording material after the color is formed, the diazonium salt is subjected to decomposition reaction so as to lose reactivity with the coupler. Thus, the image can be fixed (light fixation). By carrying out the light fixation in this way, the diazonium salt which has not yet reacted undergoes decomposition reaction so that the activity thereof is lost. For this reason, it is possible to suppress a change in the density of the formed image and coloration of the non-image portion (background portion), based on the generation of stain, that is, a fall in the whiteness and a fall in image contrast following the whiteness-fall.

Examples of the light source used in the light fixation include a various kinds of fluorescent lamps, a xenon lamp, and a mercury lamp. In order to perform the fixation with a high efficiency, it is preferable that the emission spectrum of these light sources is substantially consistent with the absorption spectrum of the diazonium salt in the thermal recording material.

In the invention, it is particularly preferable to use a light source radiating light having a central emission wavelength of 380 nm to 460 nm.

The thermal recording material of the invention can be used as thermal development type thermal recording material, wherein a latent image is recorded imagewise by light and the latent image is thermally developed to form an image. In this case, the image-recording step is performed by a light source such as a laser source instead of the aforementioned heating device.

By laminating plural thermal recording layers having color formation hues different from each other in the thermal recording material, the thermal recording material can be made up to a multicolor thermal recording material. The thermal recording layers to be laminated may be thermal recording layers each containing a photolytic diazonium salt.

The multicolor thermal recording material is described in, for example, JP-A Nos. 3-288688, 4-135787, 4-144784, 4-144785, 4-194842, 4-247447, 4-247448, 4-340540, 4-340541, 5-34860, 5-194842, and 09-156229.

For example, the full color thermal recording material may be made into the following embodiment: a full color thermal recording material wherein there are laminated two thermal recording layers having different color formation hues, one of the layers being made of a combination of a diazonium salt and a coupler that can react thermally with the diazonium salt to form one of the color hues, and the other of the layers being made of a combination of another diazonium salt and another coupler that can react thermally with the diazonium salt to form the other of the color hues (B layer and C layer), and a thermal recording layer made of a combination of an electron donating colorless dye and an electron accepting compound (A layer); and a full color thermal recording material wherein there are laminated the aforementioned two thermal recording layers (B layer and C layer), and a thermal recording layer made of a combination of a diazonium salt having a photosensitive wavelength different from those of the diazonium salts in the two layers, and a coupler that reacts thermally with this diazonium salt to form a color (A layer). However, in the invention, the full color thermal recording material is not limited to these embodiments.

Specifically, the full color thermal recording material of the invention may be made by laminating, on a support, a first thermal recording layer comprising an electron donating colorless dye and an electron accepting compound, or a diazonium salt having a maximum absorption wavelength of less than 350 nm and a coupler which reacts thermally with the diazonium salt (A layer), a second thermal recording layer comprising a diazonium salt having a maximum absorption wavelength of 360±20 nm and a coupler which reacts thermally with the diazonium salt to form a color (B layer), and a third thermal recording layer comprising a diazonium salt having a maximum absorption wavelength of 400±20 nm and a coupler which reacts thermally with the diazonium salt to form a color (C layer) successively.

In this case, a full color image can be recorded by selecting the color formation hues of the respective thermal recording layers in such a manner that the color hues will be three primary colors based on subtractive color mixing, that is, yellow, magenta and cyan.

About the layer structure of the full color recording material, the respective layers for forming yellow, magenta and cyan may be laminated in any order. From the viewpoint of color reproduction, it is preferable to laminate, on a support, the yellow, cyan and magenta layers in this order, or the yellow, magenta and cyan layers in this order.

In the case of the multicolor thermal recording material, the recording process thereof can be performed as follows.

First, the third thermal recording layer (C layer) is heated to form the diazonium salt and the coupler contained in this layer into a color. Next, light having a wavelength of 400±20 nm is radiated to dissolve the diazonium which is contained in the C layer and has not yet reacted. Next, heat sufficient for forming the second thermal recording layer (B layer) into a color is supplied to the thermal recording material so as to form the diazonium and the coupler contained in this layer into this color. At the same time, the C layer is intensely heated as well. However, the diazonium salt in this layer has already been decomposed and the color forming capability thereof has been lost. Thus, any color is not formed. Thereafter, the diazonium salt contained in the B layer is decomposed by radiating light having a wavelength of 360±20 nm onto the thermal recording material. Finally, heat sufficient for forming the first thermal recording layer (A layer) into a color is supplied to the thermal recording material so as to form this color. At the same time, the C layer and the B layer are intensely heated as well. However, the diazonium salts therein have already been decomposed and the color forming capabilities thereof have been lost. Thus, any color is not formed.

The thermal recording material of the invention is preferably made up to a multicolor thermal recording material as described above.

As described above, the color forming mechanism of the thermal recording layer laminated directly on the support surface (A layer) is not limited to the combination of the electron donating dye and the electron accepting dye or the combination of the diazonium salt and the coupler, which reacts thermally with the diazonium salt, to form a color. The mechanism may be a base color forming system, which contacts a basic compound to form a color, a chelate color forming system, a color forming system which reacts with a nucleophilic agent to cause elimination reaction, thereby forming a color, or any other color forming system. By forming, on this thermal recording layer, a thermal recording layer comprising a diazonium salt and a coupler which reacts with the diazonium salt to form a color, a multicolor thermal recording material can be produced.

In the case of the multicolor thermal recording material, an intermediate layer may be formed between any two thermal recording layers in order to prevent color mixing between the thermal recording layers.

The intermediate layer is made of a water-soluble polymer compound such as gelatin, phthalated gelatin, polyvinyl alcohol, or polyvinyl pyrrolidone, and may appropriately contain various additives.

In the case that the thermal recording material of the invention is a multicolor thermal recording material having a light fixation type thermal recording layer on a support, it is desirable to form a light transmittance control layer or a protective layer as an upper layer, or form these two layers as upper layers, if necessary.

The light transmittance control layer is described in JP-A Nos. 9-39395 and 9-39396.

When a component functioning as a precursor of an ultraviolet ray absorber is used in the light transmittance control layer, this ultraviolet ray absorber precursor does not function as an ultraviolet ray absorber before light having a wavelength within the range of wavelengths necessary for light fixation is radiated. Therefore, the precursor has a high light transmittance, and can cause the wavelength within the range of wavelengths necessary for light fixation to be sufficiently transmitted when the light fixation type thermal recording layer is light-fixed. Additionally, the light transmittance control layer has a high transmittance of visible rays; thus, the light transmittance control layer does not hinder the thermal recording layer from being light-fixed.

After the light having a wavelength within the range of wavelengths necessary for the light fixation of the light fixation type thermal recording layer (photolysis of the diazonium salt by light radiation) is radiated, the ultraviolet ray absorber precursor reacts by the light, so as to function as an ultraviolet ray absorber. This ultraviolet ray absorber absorbs almost all of rays having wavelengths within the ultraviolet ray range, so that the transmittance thereof falls. Thus, the light resistance of the thermal recording material can be improved. However, the transmittance of visible rays does not change substantially since the precursor absorbs no visible rays.

A plurality of the light transmittance control layers may be formed in the thermal recording material. It is preferable to form the light transmittance control layer(s) between the thermal recording layer and the protective layer. The protective layer may be caused to have a function as the light transmittance control layer, so that the protective layer also functions as the light transmittance control layer.

### EXAMPLES

The present invention is more specifically described by the following examples. However, the invention is not limited to these examples. In the following description, the word “part(s)” and the symbol “%” means “part(s) by mass” and “% by mass”, respectively, unless otherwise specified.

### Example 1

<Preparation of Aqueous Solution of Phthalated Gelatin>

The following were mixed: 32 parts by phthalated gelatin (trade name: #801 GELATIN manufactured by Nitta Gelatin Co., Ltd.), 0.9143 part of 1,2-benzothiazoline-3-one (3.5% methanol solution manufactured by DAITO CHEMIX CORPORATION), and 367.1 parts of ion exchange water. The solid components were dissolved at 40° C., to yield an aqueous solution of phthalated gelatin.

<Preparation of Aqueous Solution of Alkali-Treated Gelatin>

The following were mixed: 25.5 parts of alkali-treated low ion content gelatin (trade name: #750 GELATIN manufactured by Nitta Gelatin Co., Ltd.), 0.7286 part of 1,2-benzothiazoline-3-one (3.5% methanol solution manufactured by DAITO CHEMIX CORPORATION), 0.153 part of calcium hydroxide, and 143.6 parts of ion exchange water. The solid components were dissolved at 50° C., to yield an aqueous solution of alkali-treated gelatin.

<Preparation of Coating Solution (a) for Yellow Thermal Recording Layer>

(Preparation of Microcapsule Solution (a) Including a Diazonium Compound (Preparation of Microcapsule-Containing Composition of the Invention))

To 16.1 parts of ethyl acetate were added 3.3 parts of the following diazonium compound (A) (maximum absorption wavelength: 420 nm), 1.1 part of the following diazonium compound (B) (maximum absorption wavelength: 420 nm), 4.8 parts of monoisopropylbiphenyl, 4.8 parts of diphenyl phthalate, and 0.4 part of diphenyl-(2,4,6-trimethylbenzoyl)phosphine oxide (trade name: Lucirin TPO, manufactured by BASF Japan Ltd.).

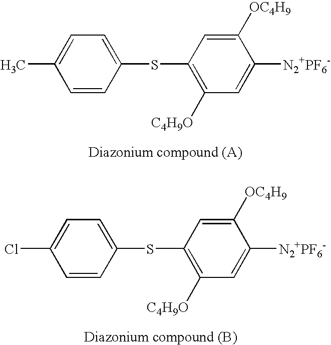

The mixture was heated to 40° C. to prepare a homogeneous solution. To the resultant mixture solution was added 0.1 part of Ti(OC₃H₇)₄ (an oil-soluble compound of a transition element from Group IV in the long-form Periodic Table) and the mixture solution was uniformly stirred. Next, thereto were added 8.6 parts of a mixture of a xylylenediisocyanate/trimethylolpropane adduct and a xylylenediisocyanate/bisphenol A adduct (trade name: Takenate D119N (50% solution in ethyl acetate), manufactured by Mitsui-Takeda Chemicals, Inc.) as a capsule wall material, and the resultant mixture was uniformly stirred to yield a mixture (I).

Separately, 16.3 parts of ion exchange water, and 0.34 part of a 50% alkylglucoxide surfactant (trade name: Scraph AG-8, manufactured by Nippon Seika Co.) were added to 58.6 parts of the aforementioned aqueous solution of phthalated gelatin, to yield a mixture (II).

The mixture (I) was added to the mixture (II), and then a homogenizer (manufactured by NIPPON SEIKI Co., Ltd.) was used to emulsify the mixture at 40° C. To the resultant emulsion were added 20 parts of water, and the resultant was made homogeneous. Thereafter, the emulsion was stirred at 40° C. to continue encapsulating reaction for 3 hours while ethyl acetate was removed. Thereafter, thereto were added 4.1 parts of an ion exchange resin (trade name: Amberlite IRA68, manufactured by Organo Corp.), and 8.2 parts of an ion exchange resin (trade name: Amberlite IRC50, manufactured by Organo Corp.), and then resultant was further stirred for 1 hour. Thereafter, the ion exchange resins were removed by filtration and the concentration of the capsule solution was adjusted to set the solid concentration in the capsule solution into 20.0%, so as to yield a microcapsule solution (a) including a diazonium compound. The particle size of the resultant microcapsules was measured with a particle size measurement apparatus (trade name: LA-700, manufactured by Horiba Co.). As a result, the median particle size thereof was 0.51 μm.

(Preparation of Coupler Compound Emulsion (a))

Into 33.0 parts of ethyl acetate were dissolved 9.9 parts of the following coupler compound (C), 9.9 parts of triphenylguanidine (manufactured by Hodogaya Chemical Co., Ltd.), 16.8 parts of 4,4′-(m-phenylenediisopropylidene)diphenol (trade name: Bisphenol M, manufactured by Mitsui Chemical Inc.), 3.3 parts of 3,3,3′,3′-tetramethyl-5,5′,6,6′-tetra(1-propyoxy)-1,1′-spirobisindane, 15.6 parts of 4-(2-ethylhexyloxy)benzenesulfonamide (manufactured by Manac Inc.), 8.8 parts of 4-n-pentyloxybenzenesulfonamide (manufactured by Manac Inc.), and 4.2 parts of calcium dodecylbenzenesulfonate (trade name: Pionin A-41-C (70% methanol solution), manufactured by Takemoto Oil & Fat Co., Ltd.), so as to yield a mixture (III).

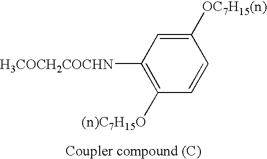

Separately, 107.3 parts of ion exchange water were mixed with 206.3 parts of the aforementioned aqueous solution of alkali-treated gelatin to yield a mixture (IV).

The mixture (III) was added to the mixture (IV), and then a homogenizer (manufactured by NIPPON SEIKI Co., Ltd.) was used to emulsify the mixture at 40° C. The resultant coupler compound emulsion was heated under reduced pressure to remove ethyl acetate, and then the concentration of the emulsion was adjusted to set the solid concentration therein into 26.5%. The particle size of the resultant coupler compound emulsion was measured with a particle size measurement apparatus (trade name: LA-700, manufactured by Horiba Co.). As a result, the median particle size thereof was 0.21 μm.

Furthermore, to 100 parts of the aforementioned coupler compound emulsion were added 9 parts of an SBR latex (trade name: SN-307 (48% liquid), manufactured by Sumika ABS Latex Co.), the concentration of which was adjusted to 26.5%, and then the emulsion was uniformly stirred to yield a coupler compound emulsion (a).

(Preparation of Coating Solution)

The aforementioned microcapsule solution (a) including a diazonium compound and the aforementioned coupler compound emulsion (a) were mixed to set the mass ratio of the coupler compound to the diazonium salt compound encapsulated to 2.2/1, so as to yield a coating solution (a) for yellow thermal recording layer.

<Preparation of Coating Solution (b) for Magenta Thermal Recording Layer>

(Preparation of Microcapsule Solution (b) Including a Diazonium Compound)

To 15.1 parts of ethyl acetate were added 2.8 parts of the following diazonium compound (D) (maximum absorption wavelength: 365 nm), 4.8 parts of diphenyl phthalate, 4.9 parts of phenyl 2-benzoyoxybenzoate, 2.2 parts of the following ester compound (E) (trade name: Light Ester TMP, manufactured by Kyoei Yushi Kagaku Co.), and 0.1 part of calcium dodecylbenzenesulfonate (trade name: Pionin A-41-C (70% methanol solution).

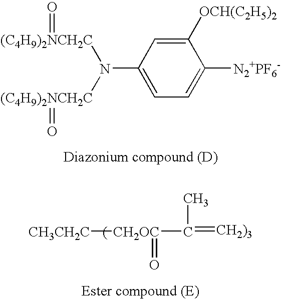

The mixture was heated to prepare a homogeneous solution. To the mixture were added 2.5 parts of a mixture of a xylylenediisocyanate/trimethylolpropane adduct and a xylylenediisocyanate/bisphenol A adduct (trade name: Takenate D119N (50% ethyl acetate solution), manufactured by Mitsui Takeda Chemicals, Inc.), and 6.8 parts of a xylylenediisocyanate/trimethylolpropane adduct (trade name: Takenate D110N (75% ethyl acetate solution), manufactured by Mitsui Takeda Chemicals, Inc.) as capsule wall materials, and the resultant mixture was uniformly stirred to yield a mixture (V).

Separately, 21.0 parts of ion exchange water were added to 55.3 parts of the aforementioned aqueous solution of phthalated gelatin, to yield a mixture (VI).

The mixture (V) was added to the mixture (VI), and then a homogenizer (manufactured by NIPPON SEIKI Co., Ltd.) was used to emulsify the mixture at 40° C. To the resultant emulsion were added 24 parts of water, and the resultant was made homogeneous. Thereafter, the emulsion was stirred at 40° C. to continue encapsulating reaction for 3 hours while ethyl acetate was removed. Thereafter, thereto were added 4.1 parts of an ion exchange resin (trade name: Amberlite IRA68, manufactured by Organo Corp.), and 8.2 parts of an ion exchange resin (trade name: Amberlite IRC50, manufactured by Organo Corp.), and then resultant was further stirred for 1 hour. Thereafter, the ion exchange resins were removed by filtration and the concentration of the capsule solution was adjusted to set the solid concentration in the capsule solution into 20.0%, so as to yield a microcapsule solution (b) including a diazonium compound. The particle size of the resultant microcapsules was measured with a particle size measurement apparatus (trade name: LA-700, manufactured by Horiba Co.). As a result, the median particle size thereof was 0.42 μm.

(Preparation of Coupler Compound Emulsion (b))

Into 36.9 parts of ethyl acetate were dissolved 11.9 parts of the following coupler compound (F), 14.0 parts of triphenylguanidine (manufactured by Hodogaya Chemical Co., Ltd.), 21.0 parts of 4,4′-(m-phenylenediisopropylidene)diphenol (trade name: Bisphenol M, manufactured by Mitsui Chemicals Inc.), 7.0 parts of 1,1-(p-hydroxyphenyl)-2-ethylhexane, 3.5 parts of 3,3,3′,3′-tetramethyl-5,5′,6,6′-tetra(1-propyoxy)-1,1′-spirobisindane, 3.5 parts of the following compound (G), 1.7 part of tricresyl phosphate, 0.8 part of diethyl maleate, and 4.5 parts of calcium dodecylbenzenesulfonate (trade name: Pionin A-41-C (70% methanol solution), manufactured by Takemoto Oil & Fat Co., Ltd.), so as to yield a mixture (VII).

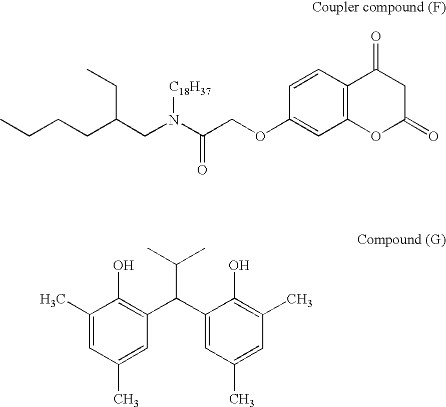

Separately, 107.3 parts of ion exchange water were mixed with 206.3 parts of the aforementioned aqueous solution of alkali-treated gelatin to yield a mixture (VIII).

The mixture (VII) was added to the mixture (VIII), and then a homogenizer (manufactured by NIPPON SEIKI Co., Ltd.) was used to emulsify the mixture at 40° C. The resultant coupler compound emulsion was heated under reduced pressure to remove ethyl acetate, and then the concentration of the emulsion was adjusted to set the solid concentration therein into 24.5%. In this way, a coupler compound emulsion (b) was yielded. The particle size of the resultant coupler compound emulsion was measured with a particle size measurement apparatus (trade name: LA-700, manufactured by Horiba Co.). As a result, the median particle size thereof was 0.22 μm.

(Preparation of Coating Solution)

The aforementioned microcapsule solution (b) including a diazonium compound and the aforementioned coupler compound emulsion (b) were mixed to set the mass ratio of the coupler compound to the diazonium salt compound encapsulated to 3.5/1. Furthermore, 0.2 part of an aqueous solution (5%) of polystyrenesulfonic acid (potassium hydroxide partially-neutralized type) was mixed with 10 parts of the capsule solution, so as to yield a coating solution (b) for magenta thermal recording layer.

<Preparation of Coating Solution (c) for Cyan Thermal Recording Layer>

(Preparation of Microcapsule Solution (c) Including an Electron Donating Colorless Dye Precursor)

To 18.1 parts of ethyl acetate were added 7.6 parts of the following electron donating dye (H), 6.0 parts of a mixture of 1-methylpropylphenyl-phenylmethane and 1-(1-methylpropylphenyl)-2-phenylethane (trade name: Hysol SAS-310, manufactured by Japan Oil Co., Ltd.), and 10.0 parts of the following compound (I) (trade name: Irgaperm 2140, manufactured by Chiba-Geigy Inc.).

Electron Donating Colorless Dye Processor (H)

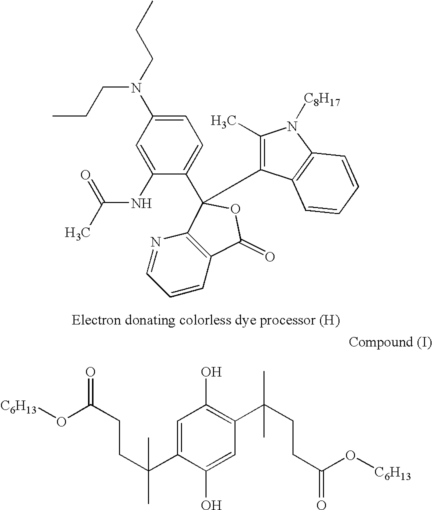

The mixture solution was heated to prepare a homogeneous solution. To the mixture were added 7.2 parts of a xylylenediisocyanate/trimethylolpropane adduct (trade name: Takenate D110N (75% ethyl acetate solution), manufactured by Mitsui Takeda Chemicals, Inc.) and 5.3 parts of polymethylene polyphenyl polyisocyanate (trade name: Millionate MR-200, manufactured by Nippon Polyurethane Industries, Co., Ltd.) as capsule wall materials, and the resultant was uniformly stirred to yield a mixture (1×).

Separately, 9.5 parts of ion exchange water, 0.17 part of a 50% alkylglucoxide surfactant (trade name: Scraph, AG-8, manufactured by Nippon Seika Co.) and 4.3 parts of sodium dodecylbenzenesulfonate (10% aqueous solution) were added to 28.8 parts of the aforementioned aqueous solution of phthalated gelatin, to yield a mixture (X).

The mixture (IX) was added to the mixture (X), and then a homogenizer (manufactured by NIPPON SEIKI Co., Ltd.) was used to emulsify the mixture at 40° C. To the resultant emulsion were added 50 parts of water and 0.20 part of tetraethylenepentamine, and the resultant was made homogeneous. Thereafter, the emulsion was stirred at 65° C. to continue encapsulating reaction for 3 hours while ethyl acetate was removed. The concentration of the capsule solution was adjusted to set the solid concentration in the capsule solution into 33%, so as to yield a microcapsule solution. The particle size of the resultant microcapsules was measured with a particle size measurement apparatus (trade name: LA-700, manufactured by Horiba Co.). As a result, the median particle size thereof was 1.00 μm.

Furthermore, to 100 parts of the aforementioned microcapsule solution were added 3.7 parts of a 25% aqueous solution of sodium dodecylbenzenesulfonate (trade name: NEOPELEX F-25, manufactured by Kao Corp.) and 4.3 parts of a fluorescent brightener containing a 4,4′-bistriazinylaminostylbene-2,2′-disulfone derivative (trade name: Kaycoll BXNL, manufactured by Nippon Soda Co., Ltd.), and then the mixture was uniformly stirred to yield a microcapsule solution (c) including an electron donating colorless dye precursor.

(Preparation of Electron Accepting Compound Dispersion (c))

To 11.3 parts of the aforementioned aqueous solution of phthalated gelatin were added 30.1 parts of ion exchange water, 15 parts of 4,4′-(p-phenylenediisopropylidene)diphenol (trade name: bisphenol P, manufactured by Mitsui Petrochemical Co.) and 3.8 parts of a 2% aqueous solution of sodium 2-ethylhexylsuccinate, and then the solid components were dispersed through the night with a ball mill to yield a dispersion. The solid concentration in this dispersion was 26.6%.

To 100 parts of the dispersion were added 45.2 parts of the aforementioned aqueous solution of alkali-treated gelatin, and the mixture was stirred for 30 minutes. Thereafter, ion exchange water was added thereto so as to set the solid concentration in the dispersion to 23.5%. In this way, an electron accepting compound dispersion (c) was yielded.

(Preparation of Coating Solution)

The aforementioned microcapsule solution (c) including an electron donating colorless dye precursor and the electron accepting compound dispersion (c) were mixed to set the mass ratio of the electron accepting compound/the electron donating dye precursor to 10/1, thereby yielding a coating solution (c) for cyan thermal recording layer.

<Preparation of Coating Solution for Intermediate Layer>

The following were mixed: 100.0 parts of alkali-treated low ion content gelatin (trade name: #750 gelatin, manufactured by Nitta gelatin Inc.), 2.857 parts of 1,2-benzothiazoline-3-one (3.5% methanol solution, manufactured by Daito Chemical Industries, Ltd.), 0.5 part of calcium hydroxide, and 521.643 parts of ion exchange water. The solid components were dissolved at 50° C. to yield an aqueous solution for preparing an intermediate layer.

The following were mixed to prepare a coating solution for intermediate layer: 10.0 parts of the aforementioned aqueous solution for preparing an intermediate layer, 0.05 part of sodium (4-nonylphenoxytrioxyethylene)butylsulfonate (2.0% aqueous solution, manufactured by Sankyo Chemicals, Co., Ltd.), 3.0 parts of boric acid (4.0% aqueous solution), 0.19 part of polystyrene sulfonic acid (potassium hydroxide partially-neutralized type), 3.42 parts of a 4% aqueous solution of the following compound (J) (manufactured by Wako Pure Chemical Ltd.), 1.13 part of a 4% aqueous solution of the following compound (J′) (manufactured by Wako Pure Chemical Ltd.) and 0.67 part of ion exchange water.

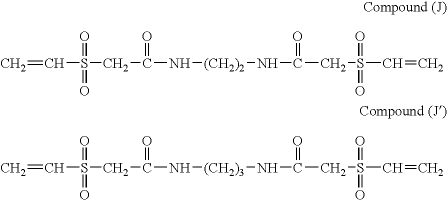

<Preparation of Coating Solution for Optical Transmittance Control Layer>

(Preparation of Microcapsule Solution for Ultraviolet Absorber Precursor)

Into 71 parts of ethyl acetate were dissolved 14.5 parts of [2-allyl-6-(2H-benzotriazole-2-yl)-4-t-octylphenyl]benzenesulfonate, 5.0 parts of 2,2′-t-octylhydroquinone, 3.8 parts of tricresyl phosphate, 3.8 parts of α-methylstyrene dimer (trade name: MSD-100, manufactured by Mitsui Chemical Inc.), and 0.45 part of calcium dodecylbenzenesulfonate (trade name: Pionin A-41-C (70% methanol solution), manufactured by Takemoto Oil & Fat Co., Ltd.), so as to prepare a homogeneous solution. To the mixture solution were added 54.7 parts of a xylylenediisocyanate/trimethylolpropane adduct (trade name: Takenate D110N (75% ethyl acetate solution), manufactured by Mitsui Takeda Chemicals, Inc.) as a capsule wall material, and the resultant mixture was uniformly stirred to yield a mixture solution of the ultraviolet absorber precursor.

Separately, 8.9 parts of 30% aqueous solution of phosphoric acid and 532.6 parts of ion exchange water were mixed with 52 parts of itaconic acid-modified polyvinyl alcohol (trade name: KL-318, manufactured by Kuraray Co., Ltd.), so as to prepare a polyvinyl alcohol (PVA) aqueous solution for a microcapsule solution of the ultraviolet absorber precursor.

To 516.06 parts of the aforementioned polyvinyl alcohol (PVA) aqueous solution for a microcapsule solution of the ultraviolet absorber precursor was added aforementioned mixture of the ultraviolet absorber precursor, and then a homogenizer (manufactured by NIPPON SEIKI Co., Ltd.) was used to emulsify the mixture at 20° C. To the resultant emulsion were added 254.1 parts of ion exchange water, and the resultant was made homogeneous. Thereafter, the emulsion was stirred at 40° C. to continue encapsulating reaction for 3 hours. Subsequently, thereto were added 94.3 parts of an ion exchange resin (trade name: Amberlite MB-3, manufactured by Organo Corp.), and further the mixture was stirred for 1 hour. Thereafter, the ion exchange resin was removed by filtration and the concentration of the capsule solution was adjusted to set the solid concentration in the capsule solution into 13.5%. The particle size of the resultant microcapsules was measured with a particle size measurement apparatus (trade name: LA-700, manufactured by Horiba Co.). As a result, the median particle size thereof was 0.23±0.05 μm. To 859.1 parts of this capsule solution were added 2.416 parts of carboxy-modified styrene butadiene latex (trade name: SN-307 (48% aqueous solution), manufactured by Sumitomo Norgatta) and 39.5 parts of ion exchange water, to yield a microcapsule solution of the ultraviolet absorber precursor.

(Preparation of Coating Solution for Optical Transmittance Control Layer)

The following were mixed to yield a coating solution for optical transmittance control layer: 1000 parts of the aforementioned microcapsule solution of the ultraviolet absorber precursor, 5.2 parts of a surfactant (trade name: MEGAFACE F-120, 5% aqueous solution, manufactured by Dainippon Ink & Chemicals, Inc.), 7.75 parts of a 4% aqueous solution of sodium hydroxide, and 73.39 parts of sodium (4-nonylphenoxytrioxyethylene)butylsulfonate (2.0% aqueous solution, manufactured by Sankyo Chemicals, Co., Ltd.).

<Preparation of Coating Solution for Protective Layer>

(Preparation of Polyvinyl Alcohol Solution for Protective Layer)

The following were mixed: 160 parts of vinyl alcohol/alkyl vinyl ether copolymer (trade name: EP-130, manufactured by Denka Corp.), 13.11 parts of a mixture solution of sodium alkylsulfonate and polyoxyethylene alkyl ether phosphoric acid ester (trade name: Neoscore CM-57 (54% aqueous solution), manufactured by Toho Chemical Industries, Co., Ltd.), and 3832 parts of ion exchange water. The solid components were dissolved at 90° C. for 1 hours to yield a homogeneous polyvinyl alcohol solution for protective layer.

(Preparation of Pigment Dispersion for Protective Layer)

Into 8 parts of barium sulfate (trade name: BF-21F, barium sulfate content 93% or higher, manufactured by Sakai Chemical Industries, Co.) were incorporated 0.2 part of an anionic especial polycarboxylic acid type polymer surfactant (trade name: Poise 532A (40% aqueous solution), manufactured by Kao Corp.) and 11.8 parts of ion exchange water. The solid components were dispersed with a Dyno mill to prepare a barium sulfate dispersion. The particle size of this dispersion was measured with a particle size measurement apparatus (trade name: LA-910,

manufactured by Horiba Co.) As a result, the median particle size thereof was 0.15 μm.

To 45.6 parts of the aforementioned barium sulfate dispersion were added 8.1 parts of colloidal silica (trade name: Snowtex-O (20% aqueous dispersion), manufactured by Nissan Chemical Industries, Ltd.), so as to yield a target pigment dispersion for protective layer.

(Preparation of Dispersion of Matting Agent for Protective Layer)

Into 220 parts of wheat starch (trade name: Wheat starch S, manufactured by Shinshin Shokuryo Kogyo Co.) were incorporated 3.81 parts of an aqueous dispersion of 1,2-benzisothiazoline-3-one (trade name: PROXEL B.D, manufactured by I.C.I. Ltd.) and 1976.19 parts of ion exchange water, and then the solid components were homogeneously dispersed to yield a dispersion of matting agent for protective layer.

(Preparation of Coating Solution for Protective Layer)

The following were uniformly mixed with 1000 parts of the aforementioned polyvinyl alcohol solution for protective layer to yield a coating solution for protective layer: 40 parts of a surfactant (trade name: MEGAFACE F-120, 5% aqueous solution, manufactured by Dainippon Ink & Chemicals, Inc.), 50 parts of sodium (4-nonylphenoxytrioxyethylene)butylsulfonate (2.0% aqueous solution, manufactured by Sankyo Chemicals, Co.), 49.87 parts of the aforementioned pigment dispersion for protective layer, 16.65 parts of the aforementioned dispersion of matting agent for protective layer, 48.7 parts of a dispersion of zinc stearate (trade name: Hydrin F115, 20.5% aqueous solution, manufactured by Chukyo Yushi Co., Ltd.), and 280 parts of ion exchange water.

<Production of Support>

(Preparation of Undercoat Layer Coating Solution)

To 60 parts of ion exchange water were added 40 parts of enzyme-decomposed gelatin (average molecular weight: 10000, PAGI method viscosity: 1.5 mPa's (15 mP), PAGI method jelly strength: 20 g), and the mixture was stirred at 40° C. to dissolve the gelatin. In this way, an aqueous gelatin solution for undercoat layer was prepared.

Separately, 8 parts of water-swelling synthetic mica (aspect ratio: 1000, trade name: Somashif ME100, manufactured by Cope Chemical Inc.) were mixed with 92 parts of water, and then the mica was wet-dispersed with a Visco mill to yield a mica dispersion having an average particle size of 2.0 μm. Water was added to this mica dispersion to set the concentration of mica to 5%, and then the resultant was uniformly mixed to prepare a desired mica dispersion.

To 100 parts of the aforementioned 40% aqueous gelatin solution for under coat layer, the temperature of which was 40° C., for the undercoat layer were added 120 parts of water and 556 parts of methanol, and then the resultant was sufficiently stirred and mixed. Thereafter, thereto were added 208 parts of the aforementioned 5% mica dispersion, and then the resultant was sufficiently stirred and mixed. Thereto were then added 9.8 parts of a 1.66% polyethylene oxide surfactant. The temperature of the solution was kept at from 35 to 40° C., and 7.3 parts of a gelatin hardener made of an epoxy compound were added thereto, so as to prepare an undercoat-layer coating solution (5.7%).

(Production of a Support with an Undercoat Layer)

Wood pulp made of 50 parts of LBPS and 50 parts of LBPK was beaten with a disc refiner, so as to have a Canadian freeness of 300 ml. Thereafter, to the beaten pulp were added 0.5 part of epoxidized behenic amide, 1.0 part of anionic polyacrylamide, 1.0 part of aluminum sulfate, 0.1 part of polyamidepolyamine epichlorohydrin, and 0.5 part of cationic polyacrylamide, each of the amounts being a bone-dry mass relative to the mass of the pulp. A Fourdrinier paper machine was used to make a base sheet having a weight of 114 g/m². The base sheet was subjected to calendar treatment to adjust the thickness of the sheet to 100 μm.

Next, corona discharge treatment was applied to both surfaces of the base sheet, and then a melting extruder was used to apply polyethylene to one of the surfaces to have a resin thickness of 36 μm. In this way, a resin layer having a mat surface was formed (This surface is referred to as the “back face”.). Next, a melting extruder was used to apply polyethylene containing 10% of anatase type titanium dioxide and a very small amount of ultramarine blue to the surface opposite to the back face, so as to have a resin thickness of 50 μm. In this way, a resin layer having a glossy surface was formed (This surface is referred to as the “front face”.). Corona discharge treatment was applied to the polyethylene resin coated face as the back face, and then aluminum oxide (trade name: Alumina Sol 100, manufactured by Nissan Chemical Industries, Ltd.) and silicon dioxide (trade name: Snowtex-O, manufactured by Nissan Chemical Industries, Ltd.) [mass ratio=1/2], as antioxidants, were dispersed in water, and this dispersion was applied to the back face in such a manner that the mass of the dispersion applied and dried would be 0.2 g/m². Next, corona discharge treatment was applied to the polyethylene resin coated face of the front face, and then the aforementioned undercoat-layer coating solution was applied to the front face in such a manner that the amount of applied mica would be 0.26 g/m². In this way, a support with an undercoat layer was obtained.

<Application of Coating Solutions for the Respective Thermal Recording Layers>

The following seven layers were applied all together and continuously onto a surface of the aforementioned support with the undercoat layer: the coating solution (c) for cyan thermal recording layer, the coating solution for intermediate layer (coating solution for intermediate layer A), the coating solution (b) for magenta thermal recording layer, the coating solution for intermediate layer (coating solution for intermediate layer B), the coating solution (a) for yellow thermal recording layer, the coating solution for optical transmittance control layer, and the coating solution for protective layer. The order of the described solutions corresponds to positional order from the lower to the upper. The layers were dried at a temperature of 30° C. and a humidity of 30% and at a temperature of 40° C. and a humidity of 30%, so as to yield a multicolor thermal recording material.

At this time, the amount of the applied coating solution (a) for yellow thermal recording layer was adjusted to set the amount of the solid content of the diazonium compound (A) contained in the solution to 0.117 g/m². Similarly, the amount of the applied coating solution (b) for magenta thermal recording layer was adjusted to set the amount of the solid content of the diazonium compound (D) contained in the solution to 0.206 g/m². Similarly, the amount of the applied coating solution (c) for cyan thermal recording layer was adjusted to set the amount of the solid content of the electron donating dye (H) contained in the solution to 0.355 g/m².

The coating solution for intermediate layer B, the coating solution for intermediate solution A, the coating solution for optical transmittance control layer and the coating solution for protective layer were applied to set the amounts of solid contents contained in the solutions to 2.39, 3.34, 2.35, and 1.39 g/m², respectively.

### Example 2

A microcapsule-containing composition was prepared in the same way as in Example 1 except that 0.1 part of Ti(OC₃H₇)₄ used in the item (Preparation of microcapsule solution (a) including a diazonium compound) in Example 1 was replaced by 0.1 part of Ti(OC₃H₇) 2 (CH₃COCHCOCH₃)₂ (oil-soluble), so as to yield a multicolor thermal recording material. The particle size of the resultant microcapsule particles was measured with a particle size measurement apparatus (trade name: LA-700, manufactured by Horiba Co.). As a result, the median particle size thereof was 0.50 μm.

### Example 3

A microcapsule-containing composition was prepared in the same way as in Example 1 except that 0.1 part of Ti(OC₃H₇)₄ used in the item (Preparation of microcapsule solution (a) including a diazonium compound) in Example 1 was replaced by 0.1 of Zr(OC₃H₇)₄ (oil-soluble), so as to yield a multicolor thermal recording material. The particle size of the resultant microcapsule particles was measured with a particle size measurement apparatus (trade name: LA-700, manufactured by Horiba Co.). As a result, the median particle size thereof was 0.51 μm.

### Example 4

A microcapsule-containing composition was prepared in the same way as in Example 1 except that 0.1 part of Ti(OC₃H₇) 4 used in the item (Preparation of microcapsule solution (a) including a diazonium compound) in Example 1 was replaced by 0.1 part of Ti(CH₃COCHCOCH₃)₄ (oil-soluble), so as to yield a multicolor thermal recording material. The particle size of the resultant microcapsule particles was measured with a particle size measurement apparatus (trade name: LA-700, manufactured by Horiba Co.). As a result, the median particle size thereof was 0.49 μm.

### Example 5

A microcapsule-containing composition was prepared in the same way as in Example 1 except that 0.1 part of Ti(OC₃H₇)₄ used in the item (Preparation of microcapsule solution (a) including a diazonium compound) in Example 1 was replaced by 0.1 part of Zr(CH₃COCHCOCH₃)₄ (oil-soluble), so as to yield a multicolor thermal recording material. The particle size of the resultant microcapsule particles was measured with a particle size measurement apparatus (trade name: LA-700, manufactured by Horiba Co.). As a result, the median particle size thereof was 0.50 μm.

### Example 6

A microcapsule-containing composition was prepared in the same way as in Example 1 except that 0.1 part of Ti(OH)₂(CH₃CHOHCOO)₂ (water-soluble) was added to the mixture (II) instead of the addition of 0.1 part of Ti(OC₃H₇)₄ used in the item (Preparation of microcapsule solution (a) including a diazonium compound) in Example 1, so as to yield a multicolor thermal recording material. The particle size of the resultant microcapsule particles was measured with a particle size measurement apparatus (trade name: LA-700, manufactured by Horiba Co.). As a result, the median particle size thereof was 0.51 μm.

### Comparative Example 1

A microcapsule-containing composition was prepared in the same way as in Example 1 except that 0.1 part of Ti(OC₃H₇)₄ used in the item (Preparation of microcapsule solution (a) including a diazonium compound) in Example 1 was not added, so as to yield a multicolor thermal recording material. The particle size of the resultant microcapsule particles was measured with a particle size measurement apparatus (trade name: LA-700, manufactured by Horiba Co.). As a result, the median particle size thereof was 0.46 μm.

<<Evaluation>>

The multicolor thermal recording materials yielded in the aforementioned way were subjected to accelerated aging treatment for conditions described below, then the color forming densities before the treatment and after the treatment were measured in a manner described below, so as to evaluate density change in the thermal recording materials. The results are shown in Table 1.

(1) Accelerated Aging Treatment

Each of the thermal recording materials was allowed to stand in a thermostat the environment-conditions of which were adjusted to a temperature of 50° C. and a relative humidity of 60% for 7 days, so as to be subjected to accelerated aging treatment.

(2) Measurement of Density of Formed Color

Each of the thermal recording materials before and after the accelerated aging treatment was allowed to stand in an environment having a temperature of 23° C. and a relative humidity of 50% for 24 hours. Thereafter, a digital printer (trade name: NC370D, manufactured by Fuji Photo Film Co., Ltd.) was used to print a step wedge pattern in yellow. Thereafter, the optical reflection yellow densities of the middle-tone portion and the background portion were measured with an X-rite densitometer.

TABLE 1

| | | Density change | | | |
|---|---|---|---|---|---|
| | Compound of a transition element from | Image portion | | Background portion | |
| | Group IV in the long-form Periodic | Before the | After the | Before the | After the |
| | Tbable | treatment | treatment | treatment | treatment |
| Example 1 | Ti(OC₃H₇)₄ | 0.73 | 0.70 | 0.07 | 0.10 |
| Example 2 | Ti(OC₃H₇)₂(CH₃COCHCOCH₃) | 0.72 | 0.69 | 0.07 | 0.11 |
| Example 3 | Zr(OC₃H₇)₄ | 0.73 | 0.70 | 0.07 | 0.10 |
| Example 4 | Ti(CH₃COCHCOCH₃)₄ | 0.73 | 0.68 | 0.07 | 0.10 |
| Example 5 | Zr(CH₃COCHCOCH₃)₄ | 0.72 | 0.69 | 0.07 | 0.11 |
| Example 6 | Ti(OH)₂(CH₃CHOCHOO)₂ | 0.71 | 0.69 | 0.06 | 0.10 |
| Comparative | None | 0.70 | 0.52 | 0.06 | 0.12 |
| Example 1 | | | | | |

As can be understood from Table 1, in the thermal recording materials of the invention made from the microcapsule-containing compositions of the invention, which each contains a compound of a transition element from Group IV in the long-form Periodic Table, exhibit only a small change in the density of formed color, which results from accelerated aging treatment, and exhibits excellent color reproduction and excellent storage stability.

As described above, according to the first aspect of the invention, it is possible to provide a microcapsule-containing composition capable of suppressing change in the thermal sensitivity of microcapsules with the passage of time and controlling the thermal response thereof. According to the second aspect of the invention, it is possible to provide a thermal recording material which is capable of suppressing change in thermal sensitivity with the passage of time and is excellent in color reproduction.

What is claimed is:

1. A microcapsule-containing composition comprising:
microcapsules each having a microcapsule wall comprising, as a constituent, at least one selected from polyurethane and polyurea produced by polymerizing a compound having active hydrogen and an isocyanate compound; and
a compound of a transition element from Group IV in the long-form Periodic Table.

2. The microcapsule-containing composition according to claim 1, wherein the compound of a transition element from Group IV in the long-form Periodic Table is encapsulated in the microcapsule.

3. The microcapsule-containing composition according to claim 1, wherein the compound of a transition element from Group IV in the long-form Periodic Table is at least one selected from titanium compounds and zirconium compounds.

4. The microcapsule-containing composition according to claim 1, wherein the compound of a transition element from Group IV in the long-form Periodic Table is at least one selected from the group consisting of water-soluble zirconium compounds, oil-soluble zirconium compounds, water-soluble titanium compounds and oil-soluble titanium compounds.

5. The microcapsule-containing composition according to claim 1, wherein the content of the compound of a transition element from Group IV in the long-form Periodic Table is from 0.05% to 20% by mass of the isocyanate compound.

6. The microcapsule-containing composition according to claim 1, wherein the compound of a transition element from Group IV in the long-form Periodic Table is contained in the microcapsule wall.

7. A thermal recording material comprising at least one thermal recording layer made from a microcapsule-containing composition comprising microcapsules each having a microcapsule wall comprising, as a constituent, at least one selected from polyurethane and polyurea produced by polymerizing a compound having active hydrogen and an isocyanate compound; and a compound of a transition element from Group IV in the long-form Periodic Table.

8. The thermal recording material according to claim 7, wherein the compound of a transition element from Group IV in the long-form Periodic Table is encapsulated in the microcapsules.

9. The thermal recording material according to claim 7, wherein the compound of a transition element from Group IV in the long-form Periodic Table is at least one selected from titanium compounds and zirconium compounds.

10. The thermal recording material according to claim 7, wherein the compound of a transition element from Group IV in the long-form Periodic Table is at least one selected from the group consisting of water-soluble zirconium compounds, oil-soluble zirconium compounds, water-soluble titanium compounds and oil-soluble titanium compounds.

11. The thermal recording material according to claim 7, wherein the content of the compound of a transition element from Group IV in the long-form Periodic Table is from 0.05 to 20% by mass of the isocyanate compound.

12. The thermal recording material according to claim 7, wherein the compound of a transition element from Group IV in the long-form Periodic Table is contained in the microcapsule wall.

13. The thermal recording material according to claim 7, wherein the thermal recording layer comprises a diazonium salt compound and a coupler.

14. The thermal recording material according to claim 13, wherein the diazonium salt compound is encapsulated in the microcapsule.

15. The thermal recording material according to claim 7, wherein the thermal recording layer comprises an electron donating colorless dye precursor and an electron accepting compound.

16. The thermal recording material according to claim 7, further comprising plural thermal recording layers which give different color formation hues.

17. A process of preparing a microcapsule-containing composition comprising the step of: polymerizing a compound having an active hydrogen and an isocyanate compound in the presence of a compound of a transition element from Group IV in the long-form Periodic Table so as to produce microcapsules having a microcapsule wall comprising, as a constituent, at least one selected from polyurethane and polyurea.

18. The process of preparing a microcapsule-containing composition according to claim 17, wherein the compound of a transition element from Group IV in the long-form Periodic Table is at least one selected from titanium compounds and zirconium compounds.

19. The process of preparing a microcapsule-containing composition according to claim 17, wherein the compound of a transition element from Group IV in the long-form Periodic Table is at least one selected from the group consisting of water-soluble zirconium compounds, oil-soluble zirconium compounds, water-soluble titanium compounds and oil-soluble titanium compounds.

20. The process of preparing a microcapsule-containing composition according to claim 17, wherein the content of the compound of a transition element from Group IV in the long-form Periodic Table is from 0.05% to 20% by mass of the isocyanate compound.
